(19) United States
(12) Patent Application Publication
(10) Pub. No.: US 2025/0165850 A1
(43) Pub. Date: May 22, 2025

(54) SYSTEM FOR SECURE TRAINING OF MACHINE LEARNING MODELS

(71) Applicant: BANK OF AMERICA CORPORATION, Charlotte, NC (US)

(72) Inventors: Stephen Richard Belton, Garden City, NY (US); Dinesh Kumar Agrawal, Rowlett, TX (US); Kenneth L. Boyd, Mechanicsville, VA (US); Srinath S. Chakravarty, Plano, TX (US); Manmohan V. Datla, Frisco, TX (US); Steven Nathan Greene, Scarsdale, NY (US); Petar Evan Puskarich, Murphy, TX (US); Elina Shkodnik, Staten Island, NY (US); Aravind Shankaragouda Singtalur, McKinney, TX (US); Kerry M. Vaughan, Lawrenceville, NJ (US)

(73) Assignee: BANK OF AMERICA CORPORATION, Charlotte, NC (US)

(21) Appl. No.: 18/511,286

(22) Filed: Nov. 16, 2023

(51) Int. Cl. G06N 20/00

(52) U.S. Cl. CPC G06N 20/00

(57) ABSTRACT

Systems, computer program products, and methods are described herein for secure training of machine learning models. The present disclosure is configured to receive a training dataset, wherein the training dataset comprises personally identifiable information (PII); implement a data sanitization algorithm using adjustable data sanitization parameters on the training dataset to generate a corresponding sanitized training dataset; train an ML model using the sanitized training dataset; deploy the trained ML model on a live dataset; evaluate a performance accuracy of the ML model against an accuracy threshold; and iteratively adjust the data sanitization parameters for subsequent iterative re-training of the ML model until the performance accuracy of the ML model meets the accuracy threshold.

### TECHNOLOGICAL FIELD

Example embodiments of the present disclosure relate to a system for secure training of machine learning models.

### BACKGROUND

In an era where machine learning models, such as large language models (LLMs), are essential for advancing business intelligence and automating decision-making, there is a need to leverage computing resources for their training effectively. However, training these models often requires large volumes of sensitive data, including personally identifiable information (PII), raising significant privacy and security concerns. The challenge lies in utilizing this data to train machine learning models without exposing the raw PII to vulnerabilities associated with processing and storage in potentially insecure environments, like public clouds.

Applicant has identified a number of deficiencies and problems associated with for secure training of machine learning models. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for secure training of machine learning models.

In one aspect, a system for secure training of machine learning models is presented. The system comprising: a data sanitization subsystem, wherein the data sanitization subsystem is configured to: receive a training dataset, wherein the training dataset comprises personally identifiable information (PII); and implement a data sanitization algorithm using adjustable data sanitization parameters on the training dataset to generate a corresponding sanitized training dataset; a machine learning (ML) subsystem operatively coupled to the data sanitization subsystem, wherein the ML subsystem is configured to: train an ML model using the sanitized training dataset; and deploy the trained ML model on a live dataset; an adaptive retraining subsystem operatively coupled to the data sanitization subsystem and the ML subsystem, wherein the adaptive retraining subsystem is configured to: evaluate a performance accuracy of the ML model against an accuracy threshold; and adjust the data sanitization parameters for subsequent iterative re-training of the ML model until the performance accuracy of the ML model meets the accuracy threshold.

In some embodiments, the adjustable data sanitization parameters comprise thresholds for granularity of sanitizing the training dataset, such that a specificity of data transformation is controlled resulting in a balancing of data privacy with data utility for the ML model.

In some embodiments, the adjustable data sanitization parameters are determined based on at least a sensitivity of the PII contained within the training dataset, such that data sanitization parameters are adjusted to apply a level of sanitization directly proportional to the sensitivity of the PII.

In some embodiments, at each iteration, the data sanitization subsystem is further configured to: receive, from the adaptive retraining subsystem, feedback associated with the performance accuracy of the ML model; automatically adjust the data sanitization parameters based on at least the feedback; and implement the data sanitization algorithm using the adjusted data sanitization parameters on the training dataset to generate the corresponding sanitized training dataset.

In some embodiments, the data sanitization algorithm comprises one or more algorithms capable of executing data masking techniques such as character shuffling, character substitution, or nulling out data to mask the PII in the training dataset.

In some embodiments, the data sanitization algorithm comprises one or more algorithms capable of executing data obfuscation techniques such as noise addition, data aggregation, or data perturbation to obfuscate the PII in the training dataset.

In some embodiments, the data sanitization algorithm comprises one or more algorithms capable of executing data encryption techniques such as symmetric encryption, asymmetric encryption, or hashing to encrypt the PII in the training dataset.

In some embodiments, the adaptive retraining subsystem is configured to: record a history of data sanitization parameter adjustments over multiple iterations, facilitating an establishment of a parameter adjustment trajectory to inform subsequent re-training efforts.

In some embodiments, selectively applying a plurality of data sanitization algorithms in subsequent iterative re-training of the ML model until the performance accuracy of the ML model meets the accuracy threshold.

In another aspect, a computer program product for secure training of machine learning models is presented. The computer program product comprising a non-transitory computer-readable medium comprising code configured to cause an apparatus to: receive a training dataset, wherein the training dataset comprises personally identifiable information (PII); implement a data sanitization algorithm using adjustable data sanitization parameters on the training dataset to generate a corresponding sanitized training dataset; train an machine learning (ML) model using the sanitized training dataset; deploy the trained ML model on a live dataset; evaluate a performance accuracy of the ML model against an accuracy threshold; and iteratively adjust the data sanitization parameters for subsequent iterative re-training of the ML model until the performance accuracy of the ML model meets the accuracy threshold.

In yet another aspect, a method for secure training of machine learning models is presented. The method comprising: receiving a training dataset, wherein the training dataset comprises personally identifiable information (PII); implementing a data sanitization algorithm using adjustable data sanitization parameters on the training dataset to generate a corresponding sanitized training dataset; training an ML model using the sanitized training dataset; deploying the trained ML model on a live dataset; evaluating a performance accuracy of the ML model against an accuracy threshold; and iteratively adjusting the data sanitization parameters for subsequent iterative re-training of the ML model until the performance accuracy of the ML model meets the accuracy threshold.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for secure training of machine learning models, in accordance with an embodiment of the invention;

FIG. 2 illustrates an exemplary machine learning (ML) subsystem architecture, in accordance with an embodiment of the invention; and

FIG. 3 illustrates a process flow for secure training of machine learning models, in accordance with an embodiment of the invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In an era where machine learning models, such as large language models (LLMs), are essential for advancing business intelligence and automating decision-making, there is a need to leverage computing resources for their training effectively. However, training these models often requires large volumes of sensitive data, including personally identifiable information (PII), raising significant privacy and security concerns. The challenge lies in utilizing this data to train machine learning models without exposing the raw PII to vulnerabilities associated with processing and storage in potentially insecure environments, like public clouds.

Current methods for protecting PII during machine learning processes involve either keeping all data on-premises, which limits the computational power and efficiency gains offered by cloud services, or accepting the exposure associated with using cloud services. Both approaches are suboptimal; the former compromises on the scalability and functionality of AI systems, while the latter could lead to breaches of privacy and non-compliance with regulatory standards. Therefore, there is a pressing need for a system that allows for the secure usage of PII in the training of machine learning models.

Embodiments of the invention address these challenges by providing a system that implements advanced data obfuscation techniques to prevent the reconstruction or re-identification of personally identifiable information (PII). The system may be designed to allow for the use of scalable cloud computing resources, thus maintaining high standards of data confidentiality during the training of machine learning models. In parallel, the obfuscation process may be calibrated to ensure that the quality and accuracy of these models are not compromised, permitting them to produce reliable and precise outputs for specific industry use cases. To facilitate the wide-scale deployment of AI technologies in environments with demanding privacy norms, embodiments of the invention seek to optimize the trade-off between the degree of data obfuscation and the precision of model outputs. This balance is crucial for enabling organizations in sensitive sectors to harness the power of artificial intelligence while adhering to rigorous data protection standards.

While the present disclosure primarily addresses the handling of Personally Identifiable Information PII within the context of training machine learning models, it is pertinent to note that the outlined processes may be equally applicable to the protection of confidential information. The data sanitization techniques described herein, designed to prevent the unauthorized reconstruction of PII, may be employed to safeguard any category of sensitive data. Thus, the principles and methods for securing PII can be adapted to preserve the confidentiality of proprietary information, ensuring that such data remains protected during the utilization of machine learning capabilities.

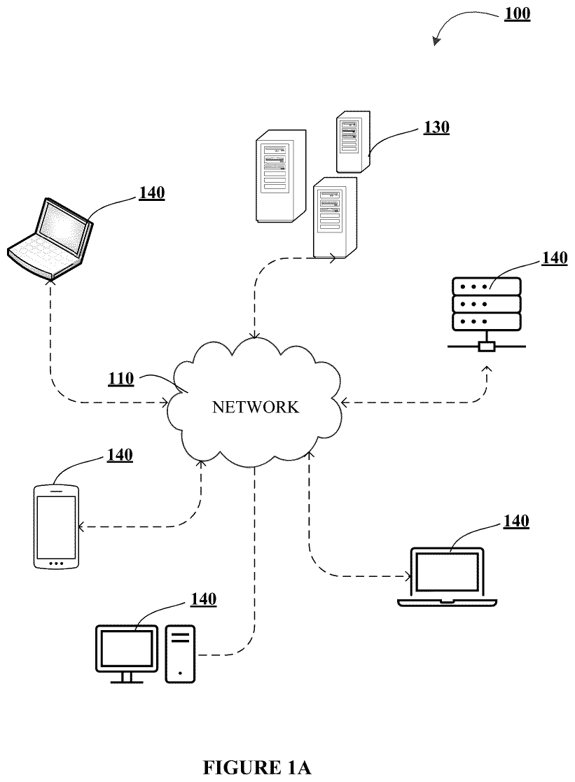

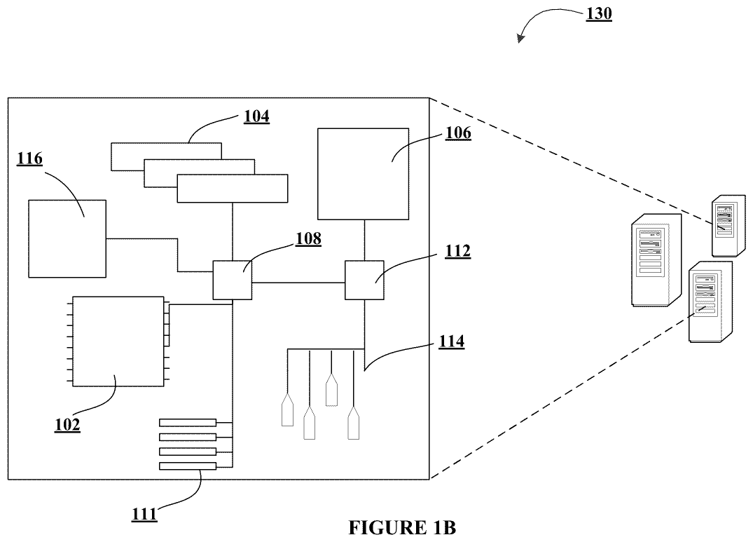

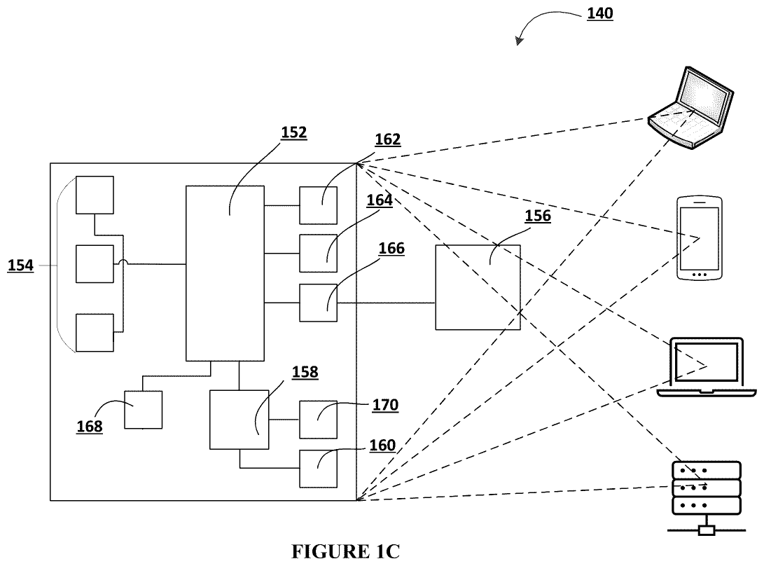

FIGS. 1A-1C illustrate technical components of an exemplary distributed computing environment for secure training of machine learning models 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 may include or be operatively coupled to a number of subsystems to execute the portions of processes described herein. A subsystem may refer to a distinct functional unit within a system, designed to perform a specific function or set of functions. In various embodiments, a subsystem may comprise both hardware and software components that work in concert to achieve the designated tasks. For example, in some embodiments, a “subsystem” may include processing circuitry, algorithms, routines, storage media, network interfaces, input/output mechanisms, and the like. In some embodiments, each subsystem may include one or more units, each designed to perform a specific function or set of functions within the broader scope of the subsystem's objectives. These units may utilize the processing circuitry, algorithms, routines, storage media, network interfaces, and input/output mechanisms associated with the subsystem to execute their designated tasks. In some embodiments, subsystem may operate independently or in conjunction with other subsystems to achieve system-wide objectives. In some cases, similar or common hardware may be shared across multiple subsystems, obviating the need for duplicate hardware. Components of a subsystem may be housed together or separately, depending on system architecture and functional requirements.

As described in further detail herein, in an example embodiment, the processor 102 may include or be operatively coupled to a data sanitization subsystem. The data sanitization subsystem may be configured to process a training dataset containing personally identifiable information (PII) through various sanitation techniques, governed by adjustable data sanitization parameters. These adjustable data sanitization parameters allow for a customized approach to data transformation, sensitive to the privacy level required and the training needs of the ML model. To this end, the data sanitization subsystem may employ data sanitization algorithms capable of masking, obfuscating, and/or encrypting the PII in the training dataset. Data masking techniques such as character shuffling, character substitution, or nulling out data may serve to conceal the PII by altering its appearance while maintaining its usability for analytics and processing. Obfuscation methods such as noise addition, data aggregation, or data perturbation may provide additional layers of security, disguising the PII to prevent direct or indirect association with an individual. For circumstances that demand stringent data protection, encryption algorithms—including symmetric and asymmetric encryption or hashing—may be utilized to transform PII into a secure and non-readable form, effectively safeguarding the information from unauthorized access. Together, these techniques constitute a robust framework within the data sanitization subsystem to ensure the privacy of sensitive information without compromising the functional needs of the ML models.

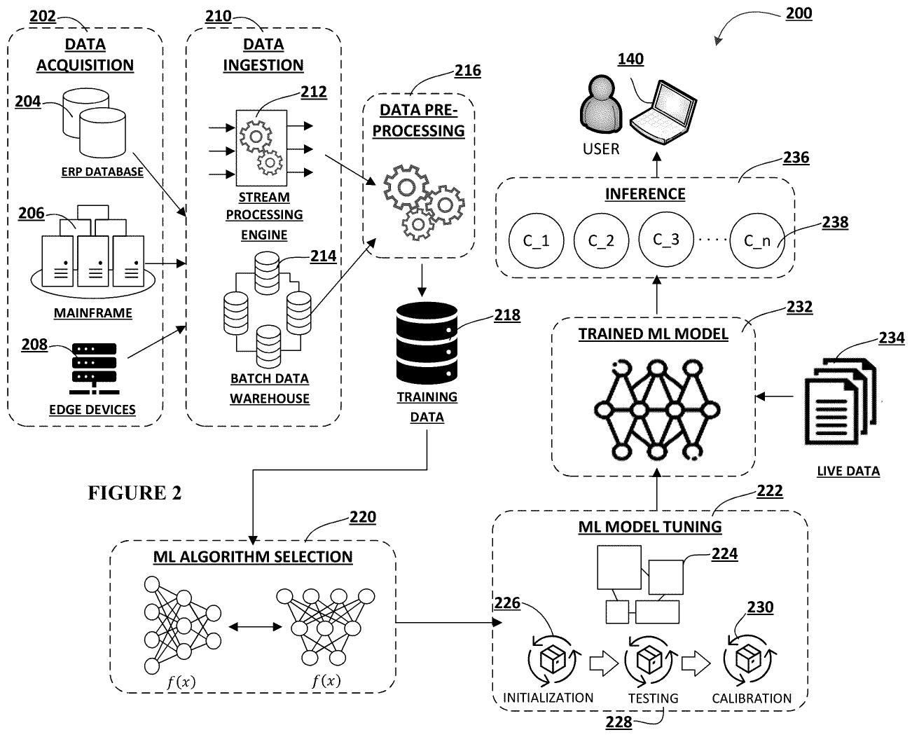

In another example embodiment, the processor 102 may include or be operatively coupled to an ML subsystem. The ML subsystem may be configured to handle the entire lifecycle of data processing, model training, and inference generation, as described in further detail in FIG. 2.

In yet another example embodiment, the processor 102 may include or be operatively coupled to an adaptive retraining subsystem. The adaptive retraining subsystem may be configured to refine and enhance the ML model's performance. In this regard, the adaptive retraining subsystem may be configured to continually assess the ML model's accuracy against a threshold. Should the model's performance prove inadequate, the adaptive retraining subsystem may be configured to adjust the data sanitization parameters and/or the data sanitization algorithms informed by performance feedback. Such parameters determine the extent and method of data sanitization, aligning with the dual objectives of preserving data privacy and maintaining the model's utility. Through a historical analysis of parameter adjustments, the adaptive retraining subsystem may develop an informed trajectory to guide future retraining efforts, thereby optimizing the balance between privacy and predictive performance.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

FIG. 2 illustrates an exemplary machine learning (ML) subsystem architecture 200, in accordance with an embodiment of the invention. The ML subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training dataset 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training dataset 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training dataset 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training dataset 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the ML subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the ML subsystem 200 illustrated in FIG. 2 is exemplary and that other embodiments may vary. As another example, in some embodiments, the ML subsystem 200 may include more, fewer, or different components.

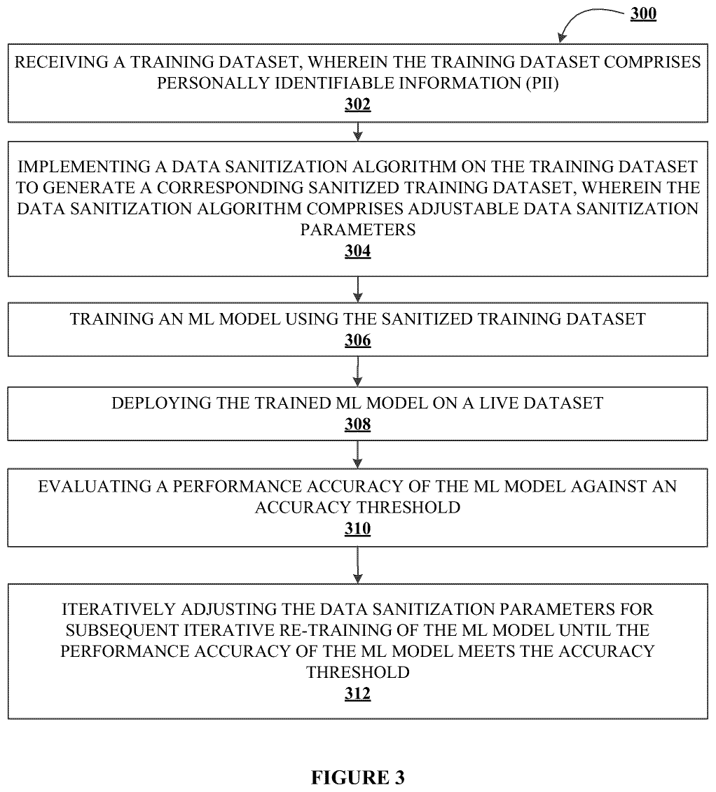

FIG. 3 illustrates a process flow for secure training of machine learning models, in accordance with an embodiment of the invention. As shown in block 302, the process flow includes receiving a training dataset, wherein the training dataset comprises personally identifiable information (PII). Dataset often contain sensitive information (e.g., PII) that must be protected to prevent potential breaches of user confidentiality and to comply with internal and/or external supervisory requirements. Sensitive information in such datasets can range from PII, such as names, social security numbers, and/or the like, to proprietary institutional data including security protocols, internal operation strategies, access control mechanisms, and/or the like. For instance, a dataset in a network security scenario at a financial institution may include logs of user transaction activities that show when and where transactions were made, including the IP addresses involved. This information is typically considered sensitive, as it can be used to identify individual users, their habits, and their financial behaviors. Additionally, the dataset might contain details on the institution's network traffic, including time-stamps, device identifiers, and the types of transactions processed. While this data is crucial for identifying patterns that may signify misappropriate activities, it also poses a privacy exposure if not handled appropriately. Security event logs are another example of sensitive data, which document all the activities that occur within the institution's network. These logs could record attempts to access the network, both authorized and unauthorized, which may be required for understanding security threats but also contain sensitive details on security practices that could be used if exposed. To handle such sensitive information with due care, embodiments of the invention employ data sanitization methods these datasets are utilized for training ML models.

As shown in block 304, the process flow may include implementing a data sanitization algorithm on the training dataset to generate a corresponding sanitized training dataset, wherein the data sanitization algorithm comprises adjustable data sanitization parameters. In some embodiments, data sanitization algorithms may refer to procedures designed to remove or modify sensitive information, such as PII, confidential information, and/or the like, from the training dataset to protect individual privacy or confidentiality. In one aspect, data sanitization algorithms may include data masking algorithms. Data masking may be a form of data sanitization where the actual data is hidden behind random characters or other data. This process may be reversible only if the original format and structure are known and the correct ‘key’ or ‘mask’ is applied. For instance, masking may replace a social security number in a dataset with a random but structurally similar set of numbers. In another aspect, data sanitization algorithms may include data obfuscation algorithms. Data obfuscation may alter the data in a way that makes the identification of the original information difficult. Data obfuscation may involve techniques such as data scrambling or use of a hash function, where the original data is replaced with a new value according to a deterministic algorithm. In yet another aspect, data sanitization algorithms may include data encryption algorithms.

In some embodiments, each data sanitization algorithm may include data sanitization parameters that may define the rules and conditions under which these sanitization techniques are applied. For instance, the data sanitization parameters may include the type of information to be sanitized, the degree to which it is sanitized, and the specific technique used. In some embodiments, the data sanitization parameters may adjustable and may be customized based on the context of the data and the desired balance between data utility and privacy. The data sanitization parameters may be adjusted to determine the strength of sanitization applicable to different types of data within the same dataset.

In some embodiments, implementing the data sanitization algorithms on a training dataset may include processing the training dataset using the data sanitization algorithms, guided by the defined data sanitization parameters to generate the sanitized training dataset. The resulting sanitized training dataset may retain the essential information without containing sensitive data. In other words, the sanitized training dataset may be a version of the training dataset that has been processed to protect sensitive data while still being functional for developing predictive models.

As shown in block 306, the process flow includes training an ML model using the sanitized training dataset. As described herein, training the ML model may include feeding the sanitized training dataset into an ML model, thereby allowing the ML model to internalize the patterns and relationships within the sanitized training dataset. The training process may be an iterative process involving adjustment of the ML mode's parameters, akin to optimizing the internal weights that influence the ML model's predictive capabilities.

As shown in block 308, the process flow includes deploying the trained ML model on a live dataset. In some embodiments, a live dataset may refer to new, previously unseen data. The ML subsystem may be configured to deploy the trained ML model on the live dataset to make predictions about new data. These predictions may then be evaluated to assess the trained ML model's performance on the live dataset. If the performance is satisfactory, the model can be used to make predictions in real-time as new data becomes available.

As shown in block 310, the process flow includes evaluating a performance accuracy of the ML model against an accuracy threshold. In some embodiments, the adaptive retraining subsystem may be configured to evaluate the performance accuracy of the trained ML model against an accuracy threshold to determine whether the trained ML model has achieved a satisfactory level of performance on live dataset. In one aspect, the accuracy threshold may be set based on the specific requirements of the application or the desired level of confidence in the predictions.

As shown in block 312, the process flow includes iteratively adjusting the data sanitization parameters for subsequent iterative re-training of the ML model until the performance accuracy of the ML model meets the accuracy threshold. In some embodiments, if the performance accuracy of the ML model does not meet the accuracy threshold, the adaptive retraining subsystem may be configured to iteratively adjust the data sanitization parameters. Following these adjustments, the training dataset is reprocessed, and the ML model is subject to retraining with the aim of enhancing its predictive accuracy. This cycle of sanitization, training, and accuracy evaluation is repeated until the performance accuracy of the ML model meets the accuracy threshold.

As described herein, each data sanitization algorithm may be governed by data sanitization parameters that dictate the extent of sanitization enforced upon the training dataset. In the instance in which the performance accuracy of the model is falls below the accuracy threshold, the adaptive retraining subsystem may be configured to adjust the data sanitization parameters to reduce the strength of the sanitization applied to the training dataset. In this regard, in example embodiments, the adjustment may be based on a difference between the performance accuracy and the accuracy threshold, i.e., how far below the accuracy threshold did the performance accuracy of the ML model measure indicating the extent to which the performance accuracy of the ML model is deficient. This process may be iterative, allowing for consecutive rounds of adjustment and retraining until the model's accuracy is deemed satisfactory according to the accuracy threshold.

In some embodiments, the adaptive retraining subsystem may be configured to record a history of data sanitization parameter adjustments over multiple iterations, facilitating an establishment of a parameter adjustment trajectory to inform subsequent re-training efforts. By maintaining a comprehensive log of adjustments, the adaptive retraining system may track which changes have been made and when, allowing for a clear understanding of the impact each adjustment has on the model's performance. Furthermore, the recorded history may aid in analyzing the direction and extent of parameter adjustments over time. The recorded history may enable the adaptive retraining subsystem to identify patterns or trends that may emerge from the retraining efforts, providing insights into the relationship between sanitization strength and model accuracy. Having a record of past parameter adjustments may provide a valuable dataset that can inform future modifications. The trajectory of past changes may suggest which parameters are more sensitive and require finer control and which are more robust against variations. With a parameter adjustment history, the adaptive retraining subsystem may efficiently approach the retraining process by potentially predicting the success of future adjustments. This predictive ability may reduce the number of necessary iterations to achieve the desired model performance.

In some embodiments, in the instance in which the performance accuracy of the model is falls below the accuracy threshold, the adaptive retraining subsystem may be configured to select an alternate data sanitization algorithm to sanitize the training dataset. In this regard, the adaptive retraining subsystem may be configured to repeatedly test various data sanitization algorithms, each time sanitizing the training dataset anew, retraining the ML model with it, and checking the model's performance accuracy against the accuracy threshold. This cycle of testing and retraining continues until the ML model achieves the required performance accuracy, as determined by the accuracy threshold. The choice of algorithm may be guided by the specific aim to improve the model's performance with each iteration.

The various data sanitization algorithms used by the adaptive retraining subsystem may be predetermined and vetted before integration into the overall system. ensuring that each algorithm adheres to the necessary standards for data protection and is capable of achieving the desired balance between data privacy and utility for machine learning purposes. Before deployment, each data sanitization algorithm may undergo an evaluation process to assess their effectiveness in sanitizing data while maintaining utility for training accurate ML models. Factors such as the sensitivity of PII, the data's relevance to the ML model's learning objectives, and compliance with data protection recommendations may also considered. The vetting process may also include testing the data sanitization algorithms against various types and volumes of data to ensure robustness and scalability. Data sanitization algorithms that pass this vetting process may then be cataloged and made accessible to the adaptive retraining subsystem. The adaptive retraining subsystem may be configured to select from these vetted options when needed. As described herein, this selection is informed by the performance feedback of the ML model, ensuring that the choice of sanitization method is appropriate for the specific needs of the dataset and/or the model.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for secure training of machine learning models, the system comprising:
a data sanitization subsystem, wherein the data sanitization subsystem is configured to:
receive a training dataset, wherein the training dataset comprises personally identifiable information (PII); and
implement a data sanitization algorithm on the training dataset to generate a corresponding sanitized training dataset, wherein the data sanitization algorithm comprises adjustable data sanitization parameters;
a machine learning (ML) subsystem operatively coupled to the data sanitization subsystem, wherein the ML subsystem is configured to:
train an ML model using the sanitized training dataset; and
deploy the trained ML model on a live dataset;
an adaptive retraining subsystem operatively coupled to the data sanitization subsystem and the ML subsystem, wherein the adaptive retraining subsystem is configured to:
evaluate a performance accuracy of the ML model against an accuracy threshold; and
iteratively adjust the data sanitization parameters for subsequent iterative re-training of the ML model until the performance accuracy of the ML model meets the accuracy threshold.

2. The system of claim 1, wherein the adjustable data sanitization parameters comprise thresholds for granularity of sanitizing the training dataset, such that a specificity of data transformation is controlled resulting in a balancing of data privacy with data utility for the ML model.

3. The system of claim 1, wherein the adjustable data sanitization parameters are determined based on at least a sensitivity of the PII contained within the training dataset, such that data sanitization parameters are adjusted to apply a level of sanitization directly proportional to the sensitivity of the PII.

4. The system of claim 1, wherein, at each iteration, the data sanitization subsystem is further configured to:
receive, from the adaptive retraining subsystem, feedback associated with the performance accuracy of the ML model;
automatically adjust the data sanitization parameters based on at least the feedback; and
implement the data sanitization algorithm using the adjusted data sanitization parameters on the training dataset to generate the corresponding sanitized training dataset.

5. The system of claim 1, wherein the data sanitization algorithm comprises one or more algorithms capable of executing data masking techniques such as character shuffling, character substitution, or nulling out data to mask the PII in the training dataset.

6. The system of claim 1, wherein the data sanitization algorithm comprises one or more algorithms capable of executing data obfuscation techniques such as noise addition, data aggregation, or data perturbation to obfuscate the PII in the training dataset.

7. The system of claim 1, wherein the data sanitization algorithm comprises one or more algorithms capable of executing data encryption techniques such as symmetric encryption, asymmetric encryption, or hashing to encrypt the PII in the training dataset.

8. The system of claim 1, wherein the adaptive retraining subsystem is configured to:
record a history of data sanitization parameter adjustments over multiple iterations, facilitating an establishment of a parameter adjustment trajectory to inform subsequent re-training efforts.

9. The system of claim 1, wherein the adaptive retraining subsystem is further configured to:
selectively applying a plurality of data sanitization algorithms in subsequent iterative re-training of the ML model until the performance accuracy of the ML model meets the accuracy threshold.

10. A computer program product for secure training of machine learning models, the computer program product comprising a non-transitory computer-readable medium comprising code configured to cause an apparatus to:
receive a training dataset, wherein the training dataset comprises personally identifiable information (PII);
implement a data sanitization algorithm using adjustable data sanitization parameters on the training dataset to generate a corresponding sanitized training dataset;
train a machine learning (ML) model using the sanitized training dataset;
deploy the trained ML model on a live dataset;
evaluate a performance accuracy of the ML model against an accuracy threshold; and
iteratively adjust the data sanitization parameters for subsequent iterative re-training of the ML model until the performance accuracy of the ML model meets the accuracy threshold.

11. The computer program product of claim 10, wherein the adjustable data sanitization parameters comprise thresholds for granularity of sanitizing the training dataset, such that a specificity of data transformation is controlled resulting in a balancing of data privacy with data utility for the ML model.

12. The computer program product of claim 10, wherein the adjustable data sanitization parameters are determined based on at least a sensitivity of the PII contained within the training dataset, such that data sanitization parameters are adjusted to apply a level of sanitization directly proportional to the sensitivity of the PII.

13. The computer program product of claim 10, wherein, at each iteration, the code further causes the apparatus to:
receive feedback associated with the performance accuracy of the ML model;
automatically adjust the data sanitization parameters based on at least the feedback; and
implement the data sanitization algorithm using the adjusted data sanitization parameters on the training dataset to generate the corresponding sanitized training dataset.

14. The computer program product of claim 10, wherein the code further causes the apparatus to:
record a history of data sanitization parameter adjustments over multiple iterations, facilitating an establishment of a parameter adjustment trajectory to inform subsequent re-training efforts.

15. The computer program product of claim 10, wherein the code further causes the apparatus to:
selectively apply a plurality of data sanitization algorithms in subsequent iterative re-training of the ML model until the performance accuracy of the ML model meets the accuracy threshold.

16. A method for secure training of machine learning models, the method comprising:
receiving a training dataset, wherein the training dataset comprises personally identifiable information (PII);
implementing a data sanitization algorithm using adjustable data sanitization parameters on the training dataset to generate a corresponding sanitized training dataset;
training an ML model using the sanitized training dataset;
deploying the trained ML model on a live dataset;
evaluating a performance accuracy of the ML model against an accuracy threshold; and
iteratively adjusting the data sanitization parameters for subsequent iterative re-training of the ML model until the performance accuracy of the ML model meets the accuracy threshold.

17. The method of claim 16, wherein the adjustable data sanitization parameters comprise thresholds for granularity of sanitizing the training dataset, such that a specificity of data transformation is controlled resulting in a balancing of data privacy with data utility for the ML model.

18. The method of claim 16, wherein the adjustable data sanitization parameters are determined based on at least a sensitivity of the PII contained within the training dataset, such that data sanitization parameters are adjusted to apply a level of sanitization directly proportional to the sensitivity of the PII.

19. The method of claim 16, wherein, at each iteration, the method further comprises:
receiving feedback associated with the performance accuracy of the ML model;
automatically adjusting the data sanitization parameters based on at least the feedback; and
implementing the data sanitization algorithm using the adjusted data sanitization parameters on the training dataset to generate the corresponding sanitized training dataset.

20. The method of claim 16, wherein the method further comprises:
selectively applying a plurality of data sanitization algorithms in subsequent iterative re-training of the ML model until the performance accuracy of the ML model meets the accuracy threshold.
